(19) United States
(12) Patent Application Publication
(10) Pub. No.: US 2014/0045112 A1
(43) Pub. Date: Feb. 13, 2014

(54) ELECTROPHOTOGRAPHIC PHOTORECEPTOR, IMAGE FORMING APPARATUS, AND PROCESS CARTRIDGE

(71) Applicant: FUJI XEROX CO., LTD., Tokyo (JP)

(72) Inventors: Yoshifumi SHOJI, Kanagawa (JP); Takayuki YAMASHITA, Kanagawa (JP); Masaru AGATSUMA, Kanagawa (JP); Shinya YAMAMOTO, Kanagawa (JP); Yuko YAMANO, Kanagawa (JP)

(73) Assignee: FUJI XEROX CO., LTD., Tokyo (JP)

(21) Appl. No.: 13/889,660

(22) Filed: May 8, 2013

(30) Foreign Application Priority Data
Aug. 10, 2012 (JP) 2012-179074

(51) Int. Cl. G03G 15/00; G03G 21/18

(52) U.S. Cl. CPC G03C 1/733; G03G 21/1814
USPC 430/56; 399/111; 430/69; 399/159

(57) ABSTRACT

Provided is an electrophotographic photoreceptor including a conductive substrate having a centerline average roughness (Ra) of from 1.0 μm to 1.7 μm and a maximum height (Rmax) of from 3.0 μm to 4.0 μm as a surface roughness; and a photosensitive layer disposed on the conductive substrate, in which the outermost surface layer contains fluorine-containing particles.

### CROSS-REFERENCE TO RELATED APPLICATIONS

This application is based on and claims priority under 35 USC 119 from Japanese Patent. Application No. 2012-179074 filed Aug. 10, 2012.

### BACKGROUND

1. Technical Field

The present invention relates to an electrophotographic photoreceptor, an image forming apparatus, and a process cartridge.

2. Related Art

In the related art, an apparatus that sequentially carries out the steps of charging, exposure, developing, transfer, cleaning, and the like, using an electrophotographic photoreceptor (hereinafter referred to as a “photoreceptor” in some cases) has been widely known as an image forming apparatus in an electrophotographic system.

In the field of such an image forming apparatus, there has recently been a strong demand for high image quality and long lifetime for the apparatus, and there have been proposed a method for decreasing the abrasion of a surface layer of a photoreceptor and a method for dispersing fluorine particles in a surface layer in an electrophotographic photoreceptor.

### SUMMARY

According to an aspect of the invention, there is provided an electrophotographic photoreceptor including a conductive substrate having a centerline average roughness (Ra) of from 1.0 μm to 1.7 μm and a maximum height (Rmax) of from 3.0 μm to 4.0 μm as a surface roughness; and a photosensitive layer dispose on the conductive substrate, in which the outermost surface layer contains fluorine-containing particles.

### BRIEF DESCRIPTION OF THE DRAWINGS

Exemplary embodiments of the present invention will be described in detail based on the following figures, wherein:

FIG. 1 is a schematic partial cross-sectional view showing an example of the configuration of an electrophotographic photoreceptor according to the present exemplary embodiment;

FIGS. 2A to 2C are schematic views each showing a part of a step of preparing a conductive substrate according to the present exemplary embodiment by an impact press processing;

FIG. 3 is a schematic configuration view showing an example of an image forming apparatus according to the present exemplary embodiment; and

FIG. 4 is a schematic configuration view showing another example of the image forming apparatus according to the present exemplary embodiment.

### DETAILED DESCRIPTION

Hereinbelow, the exemplary embodiments of the in will be described.

Electrophotographic Photoreceptor

The electrophotographic photoreceptor according to the present exemplary embodiment has a conductive substrate having a centerline average roughness (Pa) of from 1.0 μm to 1.7 μm and a maximum height (Rmax) of from 3.0 μm to 4.0 μm as a surface roughness; and a photosensitive layer disposed on the conductive substrate, in which the outermost surface layer is configured to include fluorine-containing particles.

In a case where the outermost surface layer includes fluorine-containing particles by using the electrophotographic photoreceptor according to the present exemplary embodiment, the abrasion with a contact member is small at the initial stage of use and generation of image defects is suppressed. The reason is presumed as follows.

In a case where the outermost surface layer of the electrophotographic photoreceptor includes the fluorine-containing particles, a lubricating property is provided, and therefore, generation of abrasion or scratching of the outermost surface layer is suppressed, and a cleaning property for the developer remaining on the photoreceptor surface increases. Further, it is thought that the fluorine-containing particles dispersed in the outermost surface layer have a high friction with a cleaning blade in contact with the surface of the photoreceptor before the fluorine-containing particles are exposed on the surface of the photoreceptor by the abrasion of the outermost surface layer, and thus, have a great effect on the image quality or the lifetime.

However, when the electrophotographic photoreceptor is formed by coating a photosensitive layer or the like on a suitably coarse surface of a conductive substrate having a centerline average roughness (Ra) in the range of from 1.0 μm to 1.7 μm and a maximum, height (Rmax) in the range of from 3.0 μm to 4.0 μm as a surface roughness of the substrate, the outermost surface layer is not subjected to a processing of polishing or the like and the outermost surface of the electrophotographic photoreceptor becomes coarse. In this case, it is thought that the contact area of the electrophotographic photoreceptor with a contact member such as a cleaning blade is reduced, the initial friction is small, and generation of image quality defects due to the friction is suppressed, as compared with an electrophotographic photoreceptor prepared using a conductive substrate having a smooth surface.

Moreover, it is thought that in a case where the surface roughness Ra of the substrate is less than 1.0 μm, the contact area with a contact member such as a cleaning blade is large, and thus, at the initial stage of use, the friction with a contact member such as a cleaning blade easily increases; whereas in a case where the surface roughness Ra of the substrate is more than 1.7 μm, the gap with the cleaning blade increases, and thus the residual toner slips through the cleaning blade and then easily remains in the next image formation.

In addition, in a case where the surface roughness Rmax of the substrate is less than 3.0 μm, the interference of the reflected light becomes strong and interference fringes are easily generated; whereas in a case where the surface roughness Rmax of the substrate is more than 4.0 μm, an action as a carrier injection unit into the photosensitive layer is achieved, and thus, black spots are easily generated.

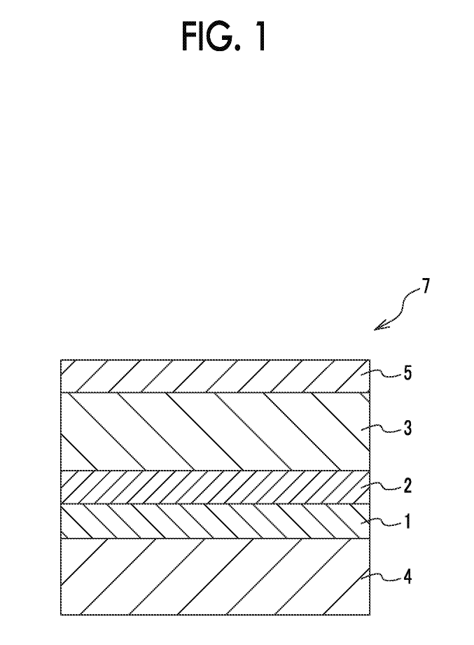

FIG. 1 is a schematic partial cross-sectional view showing an example of the configuration of the showing electrophotographic photoreceptor according to the present exemplary embodiment. In the electrophotographic photoreceptor 7 shown in FIG. 1, an undercoat layer 1 is provided on a conductive substrate 4, and a charge generating layer 2, a charge transporting; layer 3, and a protective layer 5 are sequentially provided as photosensitive layers thereon. Further, the undercoat layer 1 and the protective layer 5 may be or may not be provided. In addition, the electrophotographic photoreceptor may be a monolayered electrophotographic photoreceptor having a function obtained by the integration of the charge generating layer 2, the charge transporting layer 3, and the protective layer 5.

Conductive Substrate

The conductive substrate 4 which is a support in the electrophotographic photoreceptor 7 of the present exemplary embodiment has a centerline average roughness (Ra) of from 1.0 μm to 1.7 μm and a maximum height (Rmax) of from 3.0 μm to 4.0 μm as a surface roughness. Here, the “conductivity” implies that the volume resistivity is less than 10¹³ Ω·cm.

As the materials constituting the conductive substrate 4, in addition to aluminum, for example, metals such as copper, magnesium, silicon, zinc, stainless steel, chromium, nickel, molybdenum, vanadium, indium, gold and platinum, or alloys thereof may be used.

Examples of the shape of the conductive substrate 4 include a metal plate, a metal drum, and a metal belt.

The surface roughness Ra of the conductive substrate 4 according to the present exemplary embodiment is a centerline average roughness defined in JIS B0601 (1982), which is a value measured by a surface roughness measurement machine SURFCOM (manufactured by Tokyo Seimitsu Co., Ltd.). The surface roughness Ra of the conductive substrate 4 of the present exemplary embodiment is from 1.0 μm to 1.7 μm, preferably from 1.1 μm to 1.5 μm, and more preferably from 1.2 μm to 1.4 μm.

Furthermore, the surface roughness Rmax of the conductive substrate 4 according to the present exemplary embodiment is a maximum height defined in JIS B0601 (1982), which is a value measured by a surface roughness measurement machine SURFCOM (manufactured by Tokyo Seimitsu Co., Ltd.). The surface roughness Rmax of the conductive substrate 4 of the present exemplary embodiment is from 3.0 μm to 4.0 μm, preferably from 3.2 μm to 3.8 μm, and more preferably from 3.4 μm to 3.6 μm.

A method for controlling the surface roughness Ra of the conductive substrate 4 to from 1.0 μm to 1.7 μm and controlling the Rmax to from 3.0 μm to 4.0 μm is not particularly limited, and examples thereof include a method for roughening the surface of a substrate made of a metal, which is molded into cylinder, by etching, anodic oxidation, coarse cutting, centerless polishing, sand blasting, wet honing, or the like. These roughening methods may be used in combination of two or more kinds thereof to adjust the Ra and the Rmax to the ranges above, respectively.

Furthermore, a substrate may be prepared by an impact press processing by providing scratches on the surface of a metal mass (slag) for preparing a cylindrical substrate.

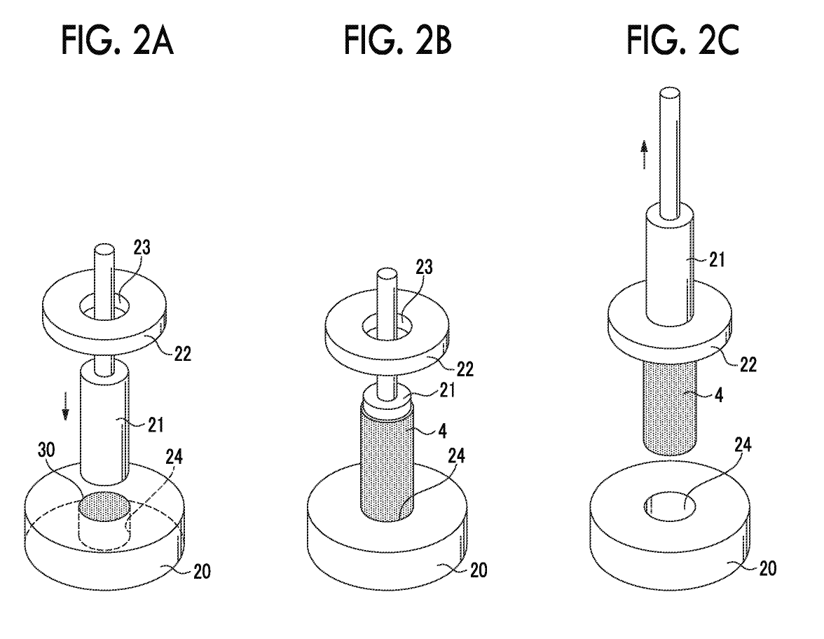

FIGS. 2A to 2C each show an example of the step of preparing the substrate 4 the electrophotographic photoreceptor 7 according to the present exemplary embodiment by an impact press processing.

First, a slag 30 having scratches provided in advance on the surface thereof is prepared and set in a circular hole 24 that is provided in a die (female) 20 as shown in FIG. 2A. Then, the slag 30 set in the die 20 pressed by a cylindrical punch (male) 21 as shown in FIG. 2B. Thus, the slag 30 is stretched cylindrically and molded so as to cover the periphery of the punch 21 from the circular hole of the die 20. After molding, the punch 21 is raised and penetrated through a central hole 23 of a stripper 22 to withdraw the punch 21 as shown in FIG. 2C, thereby obtaining a cylindrical, substrate 4.

By the impact press processing using the slag 30 having scratches on the surface, the cylindrical substrate 4 having a small thickness, an Ra of from 1.0 μm to 1.7 μm, and an Rmax of from 3.0 μm to 4.0 μm is formed. Further, the Ra and Rmax as a surface roughness of the substrate 4 are adjusted by the size (depth, length, width, or the like), the number, or the like of the scratches provided in advance on the surface of the slag 30. For example, when the number of the scratches on the surface of the slag increases, the Ra of the outer peripheral surface easily increases when molding into a cylindrical substrate, and when the depth of the surface scratches of the slag increases, the Rmax of the outer peripheral surface easily increases when molding into a cylindrical substrate.

In addition, after the cylindrical substrate 4 is molded from the slag by an impact press processing, Ra and Rmax as a surface roughness of the substrate 4 may be adjusted by applying a roughening method such as etching, anodic oxidation, coarse cutting, centerless polishing, sand blasting, and wet honing.

The thickness of the conductive substrate 4 of the present exemplary embodiment is not particularly limited, but is preferably in the range of from 0.4 mm to 0.7 mm, and more preferably from 0.4 mm to 0.5 mm. By decreasing the thickness of the conductive substrate 4, the flexibility of the substrate 4 is achieved, the substrate 4 is more uniformly susceptible to the action of a member (a cleaning blade or the like) in contact with the electrophotographic photoreceptor 7, and an image having high image quality is easily obtained.

In the electrophotographic photoreceptor 7 of the present exemplary embodiment, as the surface roughness of the conductive substrate 4, Ra may be any of from 1.0 μm to 1.7 μm and Rmax may be any of from 3.0 μm to 4.0 μm, and the surface of the conductive substrate 4 may be subjected to, for example, a treatment with an acidic aqueous solution or a boehmite treatment.

The treatments with an acidic treatment solution including phosphoric acid, chromic acid, and hydrofluoric acid are carried out as follows: first, an acidic treatment solution is prepared. The acidic treatment solution preferably has a mixing ratio with a range of from 10% by weight to 11% by weight of phosphoric acid, a range of from 3% by weight to 5% by weight of chromic acid, and a range of from 0.5% by weight to 2% by weight of hydrofluoric acid. The concentration of the total acid components is preferably in the range of 13.5% by weight to 18% by weight. The treatment temperature is preferably from 42° C. to 48° C. The film thickness is preferably from 0.3 μm to 15 μm.

The boehmite treatment is carried out by immersing the substrate in pure water at a temperature of from 90° C. to 100° C. for from 5 minutes to 60 minutes, or by bringing it into contact with heated water vapor at a temperature of from 90° C. to 120° C. for from 5 minutes to 60 minutes. The film, thickness of the coated film is preferably from 0.1 μm to 5 μm. The film may further be subjected to anodic oxidation using an electrolyte solution in which the film has lower solubility than in other kinds of electrolyte solutions, such as adipic acid, boric acid, borate, phosphate, phthalate, maleate, benzoate, tartrate, and citrate solutions.

Undercoat Layer

Next, the undercoat layer 1 will be described.

The undercoat layer 1 is constituted with an organometallic compound and a binder resin.

Examples of the organometallic compound constituting the undercoat layer 1 include organozirconium compounds such as a zirconium chelate compound, a zirconium alkoxide compound, and a zirconium coupling agent; organotitanium compounds such as a titanium chelate compound, a titanium alkoxide compound, and a titanium coupling agent; organoaluminum compounds such as an aluminum chelate compound and an aluminum coupling agent; as well as an antimony alkoxide compound, a germanium alkoxide compound, an indium alkoxide compound, an indium chelate compound, a manganese alkoxide compound, a manganese chelate compound, a tin alkoxide compound, a tin chelate compound, an aluminum silicon alkoxide compound, an aluminum titanium alkoxide compound, and an aluminum zirconium alkoxide compound. As the organometallic compound, an organozirconium compound, an organotitanium compound, and an organoaluminum compound are preferably used since they have low residual potentials and show good electrophotographic properties.

As the binder resin constituting the undercoat layer 1, any known binder resin including, for example, polyvinyl alcohol, polyvinyl methyl ether, poly-N-vinylimidazole, polyethylene oxide, ethyl cellulose, methyl cellulose, an ethylene-acrylic acid copolymer, polyamide, polyimide, casein, gelatin, polyethylene, polyester, a phenolic resin, a vinyl chloride-vinyl acetate copolymer, an epoxy resin, polyvinylpyrrolidone polyvinylpyridine, polyurethane, polyglutamic acid, and polyacrylic acid is used. These binder resins may be used in a mixture of two or more kinds thereof.

The undercoat layer 1 may contain a silane coupling agent such as vinyltrichlorosilane, vinyltrimethoxysilane, vinyltriethoxysilane, vinyltris-2-methoxyethoxysilane, vinyltriacetoxysilane, 3-glycidoxypropyltrimethoxysilane, 3-methacryloxypropyltrimethoxysilane, 3-aminopropyltriethoxysilane, 3-chloropropyltrimethoxysilane, 3-(2-aminoethylamino) propyltrimethoxysilane, 3-mercaptopropyltrimethoxysilane, 3-ureidopropyltriethoxysilane, and 2-(3,4-epoxycyclohexyl)trimethoxysilane.

An electron transporting pigment may be dispersed in the undercoat layer 1. Examples of the electron transporting pigment include organic pigments such as a perylene pigment, a bisbenzimidazoleperylene pigment, a polycyclic quinone pigment, an indigo pigment, and a quinacridone pigment, described in JP-A-47-30330; other organic pigments such as a bisazo pigment and a phthalocyanine pigment that has an electron-attracting substituent such as a cyano group, a nitro group, a nitroso group, or a halogen atom; and inorganic pigments such as zinc oxide and titanium oxide. Among these pigments, a perylene pigment, a bisbenzimidazoleperylene pigment, a polycyclic quinone pigment, zinc oxide and titanium oxide are preferably used since they have high electron mobility.

The surface of the pigment may be subjected to a surface treatment with a coupling agent or a binder resin such as those mentioned hereinabove for the purpose of controlling the dispersibility and the charge transporting property.

Furthermore, a too high content of the electron transporting pigment may lower the strength of the undercoat layer 1 and may cause film defects. Therefore, the content of the electron transporting pigment is preferably 95% by weight or less, and more preferably 90% by weight or less.

The undercoat layer 1 is formed using a coating liquid for forming an undercoat layer containing the respective constituting materials.

As a method for mixing and/or dispersing coating liquid for forming an undercoat layer, a common method using a ball mill, a roll mill, a sand mill, an attritor, ultrasonic waves, or the like is used. The mixing and/or dispersion are performed in an organic solvent, and the organic solvent may be any one that dissolves the organometallic compound and the binder resin and does not cause gelation or aggregation when an electron transporting pigment is mixed and/or dispersed therein.

Examples of the organic solvent included in the coating liquid for forming an undercoat layer include ordinary organic solvents such as methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. These may be used singly or as a mixture of two or more kinds thereof.

As a coating method when providing the undercoat layer 1, an ordinary coating method may be employed, including, for example, a blade coating method, a wire bar coating method, a spray coating method, a dipping coating method, a bead coating method, an air knife coating method, and a curtain coating method.

After the coating, the coated film is dried to obtain the undercoat layer 1, and is usually dried at a temperature capable of forming a film by evaporating the solvent.

The film thickness of the undercoat layer 1 is preferably from 1 μm to 30 μm, and more preferably from 2 μm to 25 μm.

Where necessary, the undercoat layer 1 may be provided on a conductive substrate 4. Specifically, when the conductive substrate 4 undergoes a treatment with an acidic solution or boehmite, it is preferable to form the undercoat layer 1 since the ability of the conductive substrate 4 to conceal defects tends to be insufficient.

Charge Generating Layer

The charge generating layer 2 is constituted including a charge generating material, or a charge generating material and a binder resin.

The charge generating material may be known one, including, for example, organic pigments, for example, azo pigments such as a bisazo pigment and a trisazo pigment, condensed cyclic aromatic pigments such as dibromoanthanthrone, as well as a perylene pigment, a pyrrolopyrrole pigment, and a phthalocyanine pigment, and inorganic pigments such as trigonal selenium and zinc oxide.

In a case where a light source having an exposure wavelength of from 380 nm to 500 nm is used, the charge generating material is preferably an inorganic pigment, and in a case where a light source having an exposure wavelength of from 700 nm to 800 nm is used, the charge generating material is preferably any of metal or non-metal phthalocyanine pigments. Among these, hydroxygallium phthalocyanine disclosed in JP-A-5-263007 and JP-A-5-279591; chlorogallium phthalocyanine disclosed in JP-A-5-98181; dichlorotin phthalocyanine disclosed in JP-A-5-140472 and JP-A-5-1404 and titanyl phthalocyanine disclosed in JP-A-4-189873 and JP-A-5-43813 are particularly preferable.

The charge generating material is preferably a hydroxygallium phthalocyanine pigment which has diffraction peaks at Bragg's angles (2θ±0.2°) with respect to CuKα characteristic X-rays of 7.5°, 9.9°, 12.5°, 16.3°, 18.6°, 25.1° and 28.3°; titanyl phthalocyanine which has a strong diffraction peak at Bragg's angles (2θ±0.2°) with respect to CuKα characteristic X-rays of 27.2°; and a chlorogallium phthalocyanine which has strong diffraction peaks at Bragg's angles (2θ±0.2°) with respect to CuKα characteristic X-rays of 7.4°, 16.6°, 25.5°, and 28.3°.

The binder resin constituting the charge generating layer 2 may be selected from a wide range of insulating resins, and from organic photoconductive polymers such as poly-N-vinyl carbazole, polyvinyl anthracene, polyvinyl pyrene, and polysilane. Preferable examples of the binder resin include, but are not limited to, polyvinyl butyral resins, polyarylate resins (polycondensates of bisphenols and aromatic divalent carboxylic acid such as a polycondensate of bisphenol A and phthalic acid, or the like), polycarbonate resins, polyester resins, phenoxy resins, vinyl chloride-vinyl acetate copolymers, polyamide resins, acrylic resins, polyacrylamide resins, polyvinyl pyridine resins, cellulose resins, urethane resins, epoxy resins, casein, polyvinyl alcohol resins, and polyvinyl pyrrolidone resins. These binder resins may be used alone or in combination of two or more kinds thereof.

The charge generating layer 2 is formed by vapor deposition with a charge generating material or by coating with a coating liquid for forming a charge generating layer that contains a charge generating material and a binder resin.

In the coating liquid for forming a charge generating layer, the blend ratio (by weight) of the charge generating material to the binder resin is preferably from 10:1 to 1:10. Further, as a method for dispersing these, an ordinary method such as a ball mill dispersion method, an attritor dispersion method, and a sand mill dispersion method is used. By using these dispersion methods, the change in the crystal form of the charge generating material due to the dispersion is prevented.

Moreover, for effective dispersion, the dispersed particles preferably have a particle size of 0.5 μm or less, more preferably 0.3 μm or less, and even more preferably 0.15 μm or less.

In addition, examples of the solvent used for the dispersion include ordinary organic solvents such as methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. These solvents may be used alone or as a mixture of two or more kinds thereof.

Furthermore, as a coating method used when providing the charge generating layer 2, an ordinary coating method may be employed, including, for example, a blade coating method, a wire bar coating method, a spray coating method, a dipping coating method, a bead coating method, an air knife coating method, and a curtain coating method.

The film thickness of the charge generating layer 2 is preferably from 0.1 μm to 5.0 μm, and more preferably from 0.2 μm to 2.0 μm.

Charge Transporting Layer

The charge transporting layer 3 contains a charge transporting material and a binder resin, or a charge transporting polymer material.

Examples of the charge transporting material include electron transporting compounds including quinone compounds such as p-benzoquinone, chloranil, bromanil, and anthraquinone, tetracyanoqudnodimethane compounds, fluorenone compounds such as 2,4,7-trinitrofluorenone, xanthone compounds, benzophenone compounds, cyanovinyl compounds, and ethylene compounds; and hole transporting compounds including triarylamine compounds, benzidine compounds, arylalkane compounds, aryl-substituted ethylene compounds, stilbene compounds, anthracene compounds, and hydrazone compounds. These charge transporting materials may be used singly or as a mixture of two or more kinds thereof, but are not limited thereto.

From the viewpoint of the mobility, the charge transporting material is preferably a compound of the following formula (a-1), (a-2), or (a-3):

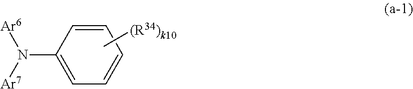

In the formula (a-1), R³⁴ represents a hydrogen atom or a methyl group, and k10 represents 1 or 2. Further, Ar⁶ and Ar⁷ represent a substituted or unsubstituted aryl group, —C₆H₄—C(R³⁸)═C(R³⁹)(R⁴⁰), or —C₆H₄—CH═CH—CH═C(Ar)₂, and examples of the substituent include a halogen atom, an alkyl group having 1 to 5 carbon atoms, an alkoxy group having 1 to 5 carbon atoms, or an amino group substituted with an alkyl group having 1 to 3 carbon atoms. In addition, R³⁸, R³⁹, and R⁴⁰ represent a hydrogen atom, a substituted or unsubstituted alkyl group, or a substituted or unsubstituted aryl group, and Ar represents a substituted or unsubstituted aryl group.

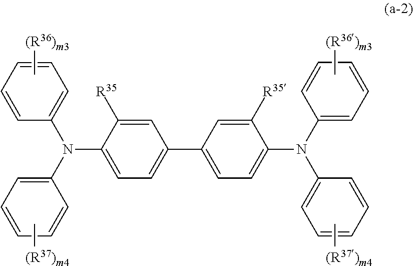

In the formula (a-2), R³⁵ and R^{35′} each independently represent a hydrogen atom, a halogen atom, an alkyl group having 1 to 5 carbon atoms, or an alkoxy group having 1 to 5 carbon atoms, R³⁶, R^{36′}, R³⁷ and R^{37′} each independently represent a halogen atom, an alkyl group having 1 to 5 carbon atoms, an alkoxy group having 1 to 5 carbon atoms, an amino group substituted with an alkyl group having 1 or 2 carbon atoms, a substituted or unsubstituted aryl group, —C(R³⁸)═C(R³⁹)(R⁴⁰), or —CH═CH—CH═C(Ar)₂, R³⁸, R³⁹ and R⁴⁰ each independently represent a hydrogen atom, a substituted or unsubstituted alkyl group, or a substituted or unsubstituted aryl group, and Ar represents a substituted or unsubstituted aryl group. m3 and m4 each independently represent an integer of 0 to 2.

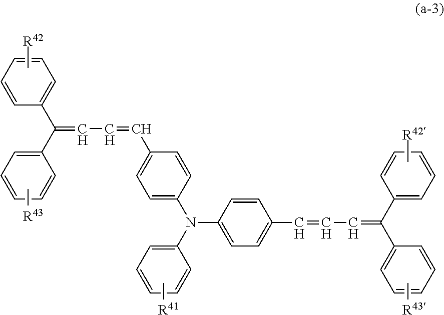

In the formula (a-3), R⁴¹ represents a hydrogen atom, an alkyl group having 1 to 5 carbon atoms, an alkoxy group having 1 to 5 carbon atoms, a substituted or unsubstituted aryl group, or —CH═CH—CH═C(Ar)₂. Ar represents a substituted or unsubstituted aryl group. R⁴², R^{42′}, R⁴³, and R^{43′} each independently represent a hydrogen atom, a halogen atom, an alkyl group having 1 to 5 carbon atoms, an alkoxy group having 1 to 5 carbon atoms, an amino group substituted with an alkyl group having 1 or 2 carbon atoms, or a substituted or unsubstituted aryl group.

The charge transporting layer 3 is configured to include, for example, a charge transporting material and a binder resin.

Specific examples of the charge transporting material include hole transporting materials, for example, oxadiazole derivatives such as 2,5-bis(p-diethylaminophenyl)-1,3,4-oxadiazole; pyrazoline derivatives such as 1,3,5-triphenyl-pyrazoline and 1-[pyridyl-(2)]-3-(p-diethylaminostyryl)-5-(p-diethylamino styryl)pyrazoline; aromatic tertiary amino compounds such as triphenylamine, N,N′-bis(3,4-dimethylphenyl)biphenyl-4-amine, tri(p-methylphenyl)aminyl-4-amine, and dibenzylaniline; aromatic tertiary diamino compounds such as N,N′-bis(3-methylphenyl)-N,N′-diphenylbenzidine; 1,2,4-triazine derivatives such as 3-(4′-dimethylaminophenyl)-5,6-di-(4′-methoxyphenyl)-1,2,4-triazine; hydrazone derivatives such as 4-diethylaminobenzaldehyde-1,1-diphenylhydrazone; quinazoline derivatives such as 2-phenyl-4-styryl-quinazoline; benzofuran derivatives such as 6-hydroxy-2,3-di(p-methoxyphenyl)benzofuran; α-stilbene derivatives such as p-(2,2-diphenylvinyl)-N,N-diphenylaniline; enamine derivatives; and carbazole derivatives such as N-ethylcarbazole, and poly-N-vinylcarbazole and derivatives thereof; electron transporting materials, for example, quinone compounds such as chloranil and bromoanthraquinone; tetracyanoquinodimethane compounds; fluorenone compounds such as 2,4,7-trinitrofluorenone and 2,4,5,7-tetranitro-9-fluorenone; xanthone compounds; and thiophene compounds; and polymers having a group composed of the above compounds in the main chain or side chain thereof. These charge transporting materials may be used singly or in combination of two or more kinds thereof.

Examples of the binder resin constituting the charge transporting layer 3 include insulating resins including a biphenyl copolymerization type polycarbonate resin, a polycarbonate resin such as a bisphenol A type and a bisphenol Z type, an acrylic resin, a methacrylic resin, a polyarylate resin, a polyester resin, a polyvinyl chloride resin, a polystyrene resin, an acrylonitrile-styrene copolymer resin, an acrylonitrile-butadiene copolymer resin, a polyvinyl acetate resin, a polyvinyl formal resin, a polysulfone resin, a styrene-butadiene copolymer resin, a vinylidene chloride-acrylonitrile copolymer resin, a vinyl chloride-vinyl acetate-maleic anhydride resin, a silicone resin, a phenol-formaldehyde resin, a polyacrylamide resin, a polyamide resin, and chlorinated rubber; organic photoconductive polymers such as polyvinyl carbazole, polyvinyl anthracene, and polyvinyl pyrene. These binder resins may be used singly or in combination of two or more kinds thereof.

Among these, a polycarbonate resin such as a bisphenol A type or a bisphenol Z type is preferable.

The charge transporting layer 3 contains fluorine-containing particles in a case where the charge transporting layer 3 is the outermost surface layer of the electrophotographic photoreceptor (layer disposed at the farthest position from the conductive substrate 4 of the photosensitive layer). When the outermost surface layer contains the fluorine-containing particles, the lubricating property is provided, the outermost surface layer is thus not easily abraded, and accordingly, it is difficult to generate scratches. In addition, the cleaning property for the developer remaining on the surface of the photoreceptor may be increased.

As the fluorine-containing particles, one or two or more are preferably selected from an ethylene tetrafluoride resin, an ethylene trifluorochloride resin, a propylene hexa fluoride resin, a vinyl fluoride resin, a vinylidene fluoride resin, an ethylene difluorodichloride resin, and copolymers thereof, but an ethylene tetrafluoride resin and vinylidene fluoride resin are particularly preferable.

The primary particle diameter of the fluorine-containing particles is preferably in the range of from 0.05 μm to 1 μm, and more preferably in the range of from 0.1 μm to 0.5 μm. If the primary particle diameter of the fluorine-containing particles is 0.05 μm or more, the aggregation during the dispersion or after the dispersion is suppressed, whereas if she primary particle diameter of the fluorine-containing particles is 1 μm or less, generation of defects in the image quality is suppressed.

The content of the fluorine-containing particles in the charge transporting layer 3 is preferably in the range of from 0.1% by weight to 40% by weight, and particularly preferably in the range of from 1% by weight to 30% by weight, based on the entire amount of the charge transporting layer. If the content of the fluorine-containing particles is 0.1% by weight or more, she improvement effect by the dispersion of the fluorine-containing particles is sufficiently obtained, whereas if the content of the fluorine-containing particles is 40% by weight or less, a decrease in light transmission is suppressed and an increase in the residual potential due to repeated use is suppressed.

Furthermore, the charge transporting layer 3 may contain lubricating particles other than the fluorine-containing particles (for example, silica particles and silicone resin particles). These lubricating particles may be used as a mixture of two or more kinds thereof.

The charge transporting layer 3 is formed by coating a coating liquid for forming a charge transporting layer, which has a charge transporting material and a binder resin, and optionally, other materials dissolved in a solvent, and then drying.

As the solvent used for forming the charge transporting layer 3, for example, aromatic hydrocarbon solvents such as toluene and chlorobenzene; aliphatic alcohol solvents such as methanol, ethanol, and n-butanol; ketone solvents such as acetone, cyclohexanone, and 2-butanone; halogenated aliphatic hydrocarbon solvents such as methylene chloride, chloroform, and ethylene chloride; cyclic or straight-chain ether solvents such as tetrahydrofuran, dioxane, ethylene glycol, and diethyl ether; and a mixed solvent thereof are used.

Furthermore, to the coating liquid for forming a charge transporting layer may be added a slight amount of a leveling agent such as silicone oil for improving smoothness of the coated film.

Examples of the method for dispersing the coating liquid for forming the charge transporting layer 3 include a method for dispersing fluorine-containing particles in a solution containing a binder resin and a charge transporting material dissolved in a solvent.

As the method for dispersing the fluorine-containing particles in the charge transporting layer, a method using a roll mill, a ball mill, a vibration ball mill, an attritor, a sand mill, a high-pressure homogenizer, an ultrasonic disperser, a colloid mill, a collision type medialess disperser, a penetration type medialess disperser, or the like is used.

In the step of preparing a coating liquid for forming she charge transporting layer 3, the temperature of the coating liquid is preferably controlled to a range of from 0° C. to 50° C. As a method for controlling the temperature of the coating liquid in the step of preparing the coating liquid to from 0° C. to 50° C., a method involving, for example, cooling with water, cooling with an air flow, cooling with a cooling medium, controlling the room temperature in the preparation step, warming with hot water, warming with hot air, warming with a heater, making facilities for preparing a coating liquid with a material hardly generating heat, making facilities or preparing a coating liquid with a material easily dissipating heat, or making facilities for preparing a coating liquid with a material easily storing heat is used.

In order to improve the dispersion stability of the dispersion and prevent, the aggregation during forming a coated film, it is also effective to add a dispersion aid. Examples of the dispersion aid include a fluorine-containing surfactant, a fluorine polymer, a silicone polymer, and a silicone oil. Further, it is also an effective unit to disperse, stir, and mix the fluorine resin and the dispersion aid in a small amount of a dispersion solvent in advance, subsequently mix the resultant with a solution formed by mixing and dissolving the charge transporting material, the binder resin, and the dispersion solvent, and then disperse them by the method above.

As the coating method used for providing the charge transporting layer 3, a dip-coating method, a push-up coating method, a spray coating method, a roll coater coating method, a wire bar coating method, a gravure coater coating method, a bead coating method, a curtain coating method, a blade coating method, an air knife coating method, or the like is used.

The film thickness of the charge transporting layer 3 is preferably set to a range of from 5 μm to 50 μm, and more preferably to a range of from 10 μm to 10 μm.

In addition, in the electrophotographic photoreceptor 7 of the present exemplary embodiment, for the purpose of preventing deterioration of the photoreceptor 7 by ozone or oxidizing ng gases or by light or heat generated in the image forming apparatus, additives such as an antioxidant and a photostabilizer may be added to the charge transporting layer 3.

Examples of the antioxidant include a hindered phenol, a hindered amine, p-phenylenediamine, an arylalkane, hydroquinone, spirochroman, spiroindanone, and derivatives thereof, an organic sulfur compound, and an organic phosphorus compound.

As specific examples of the antioxidant, examples of the hindered phenol antioxidant include 2,6-di-t-butyl-4-methylphenol, styrenated phenol, n-octadecyl-3-(3′,5′-di-t-butyl 4′-hydroxyphenyl)-propionate, 2,2′-methylene-bis-(4-methyl-6-t-butylphenol) 2-t-butyl-6-(3′-t-butyl-5′-methyl-2′-hydroxybenzyl)-4-methylphenyl-acrylate, 4,4′-butylidene-bis-(3-methyl-6-t-butylphenol), 4,4′-thio-bis-(3-methyl-6-t-butylphenol), 1,3,5-tris(4-t-butyl-3-hydroxy-2,6-dimethylbenzyl)isocyanurate, tetrakis-[methylene-3-(3′,5′-di-t-butyl-4′-hydroxy-phenyl) propionate]-methane, and 3,9-bis[2-[3-(3-t-butyl-4-hydroxy-5-methylphenyl)propionyl oxy]-1,1-dimethylethyl]-2,4,8,10-tetraoxaspiro-[5,5]-undecane.

Examples of the hindered amine compound include bis(2,2,6,6-tetramethyl-4-piperidyl)sebacate, bis(1,2,2,6,6-pentamethyl-4-piperidyl)sebacate, 1-[2-[3-(3,5-di-t-butyl-4-hydroxyphenyl)propionyloxy]ethyl]-4-[3-(3,5-di-t-butyl-4-hydroxyphenyl)propionyloxy]-2,2,6,6-tetramethylpiperidine, 8-benzyl-7,7,9,9-tetra methyl-3-octyl-1,3,8-triazaspiro[4,5]undecane-2,4-dione, 4-benzoyloxy-2,2,6,6-tetramethylpiperidine, a polycondensate of dimethyl succinate and 1-(2-hydroxyethyl)-4-hydroxy-2,2,6,6-tetramethylpiperidine, poly[6-(1,1,3,3-tetramethylbutyl)amino-1,3,5-triazin-2,4-{(2,2,6,6-tetramethyl-4-piperidinyl)imino}-1,6-hexame thylene{(2,2,6,6-tetramethyl-4-piperidinyl)imino}], bis(1,2,2,6,6-pentamethyl-4-piperidyl)-2-(3,5-di-t-butyl-4-hydroxybenzyl)-2-n-butylmalonate, and N,N′-bis(3-aminopropyl)ethylenediamine-2,4-bis[N-butyl-N-(1,2,2,6,6-pentamethyl-4-piperidyl)amino]-6-chloro-1,3,5-triazine condensate.

Examples of the organic sulfur antioxidant include dilauryl-3,3′-thiodipropionate, dimyristyl 3,3′-thiodi propionate, distearyl-3,3′-thiodipropionate, pentaerythritol-tetrakis-(2-lauryl-thiopropionate), ditridecyl-3,3′-thiodipropionate, and 2-mercaptobenzimidazole.

Examples of the organic phosphorus antioxidant include trisnonylphenyl phosphite, triphenyl phosphite, and tris(2,4-di-t-butylphenyl)phosphite.

The organic sulfur antioxidant and the organic phosphorus antioxidant are each called a secondary antioxidant, and combined use thereof with a primary antioxidant such as a phenol antioxidant and an amine antioxidant can provide synergistic effects.

Examples of the photostabilizer include a benzophenone derivative, a benzotriazole derivative, a dithiocarbamate derivative, and a tetramethyl piperidine derivative.

Examples of the benzophenone photostabilizer include 2-hydroxy-4-methoxybenzophenone, and 2-hydroxy-4-octoxybenzophenone, and 2,2′-dihydroxy-4-methoxybenzophenone.

Examples of the benzotriazole photostabilizer include 2-(2′-hydroxy-5′-methylphenyl)-benzotriazole, 2-[2′-hydroxy-3′-(3″,4″,5″,6″-tetrahydrophthalimidomethyl)-5′-methylphenyl]-benzotriazole, 2-(2′-hydroxy-3′-t-butyl-5′-methylphenyl)-5-chlorobenzotriazole, 2-(2′-hydroxy-3′,5′-t-butylphenyl)-benzotriazole, 2-(2′-hydroxy-5′-t-octylphenyl)-benzotriazole, and 2-(2′-hydroxy-3′,5′-di-t-amylphenyl)-benzotriazole.

Examples of other compounds include 2,4-di-t-butylphenyl-3′,5′-di-t-butyl-4′-hydroxybenzoate, and nickel dibutyl-dithiocarbamate.

The charge transporting layer 3 may contain at least one electron receiving substance for the purpose of improving sensitivity, reducing residual potential, and reducing fatigue during repeated use.

Examples of the electron receiving substance include succinic anhydride, maleic anhydride, dibromomaleic anhydride, phthalic anhydride, tetrabromophthalic anhydride, tetracyanoethylene, tetracyanoquinodimethane, o-dinitrobenzene, m-dinitrobenzene, chloranil, dinitroanthraquinone, trinitrofluorenone, picric acid, o-nitrobenzoic acid, p-nitrobenzoic acid, and phthalic acid. Among these, fluorenone compounds, quinine compounds, and benzene derivatives having an electron attracting substituent such as Cl, CN, and NO₂ are particularly preferable.

Protective Layer

The protective layer 5 is the outermost surface layer in the electrophotographic photoreceptor 7, and is a layer that is provided, if necessary, in order to impart resistance to abrasion, scratches, or the like on the outermost surface, or improve the transfer efficiency of a toner.

In a case where providing the protective layer 5 as an outermost surface layer, the protective layer 5 is formed to include a charge transporting material and a binder resin in a similar manner as for the charge transporting layer 3, in addition to the fluorine particles, or formed by crosslinking a crosslinkable charge transporting material.

Suitable examples of the crosslinkable charge transporting material, used in the protective layer 5 include those having at least one substituent selected from —OH, —OCH₃, —NH₂, —SH, and —COOH, and those having at least two (or three) substituents are preferable since they may increase the crosslinking density.

The charge transporting material used in the protective layer 5 is preferably a compound represented by the formula (I).

F—((—R¹—X)ₙ₁R²—Y)ₙ₂ (I)

In the formula (I), F represents an organic group derived from a compound having hole transportability, R¹ and R² each independently represent a straight-chain or branched alkylene group having 1 to 5 carbon atoms, n1 represents 0 or 1, and n2 represents an integer of 1 to 4. X represents oxygen, NH, or a sulfur atom, and Y represents —OH, —OCH₃, —NH₂, —SH, or —COOH.

In the formula (I), suitable examples of the compound having hole transportability in the organic group derived from the compound having hole transportability represented by F include an arylamine derivative. Suitable examples of the arylamine derivative include a triphenylamine derivative and a tetraphenylbenzidine derivative.

The compound represented by the formula (I) is preferably a compound represented by the following formula (II). The compound represented by the following formula (II) is excellent particularly in a degree of charge mobility, stability against oxidation, or the like,

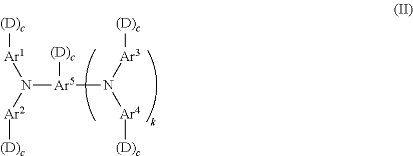

In the formula (II), Ar¹ to Ar⁴ may be the same as or different from each other and each independently represent a substituted or unsubstituted aryl group, Ar⁵ represents a substituted or unsubstituted aryl group or a substituted or unsubstituted allylene group, D represents —(—R¹—X)ₙ₁R²—Y, c's each independently represent 0 or 1, k represents 0 or 1, and the total number of D's is from 1 to 4. Further, R¹ and R² each independently represent a straight-chain or branched alkylene group having 1 to 5 carbon atoms, n1 represents 0 or 1, X represents oxygen, NH, or a sulfur atom, and Y represents —OH, —OCH, —NH₂, —SH, or —COOH.

In the formula (II), “—(—R¹—X)ₙ₁R²—Y” which represents D is the same as in the formula (I), and R¹ and R² each independently represent a straight-chain or branched alkylene group having 1 to 5 carbon atoms. n1 is preferably 1. X is preferably oxygen. Y is preferably a hydroxyl group.

Specific examples of the compound represented by the formula (I) include compounds (I)-1 to (I)-5 shown below. Further, the compound represented by the formula (I) is not limited thereto.

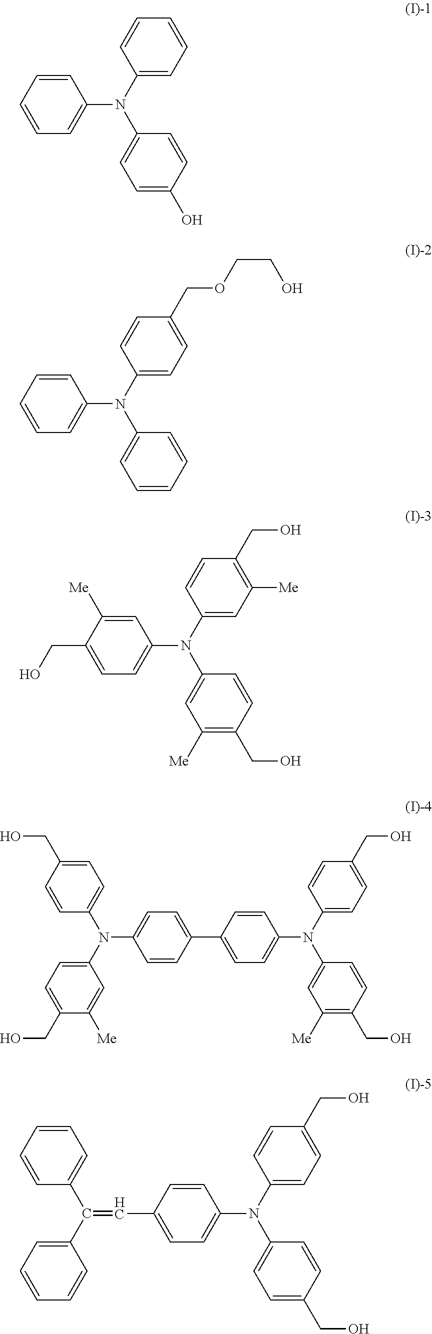 [SMILES: Oc1ccc(N(c2ccccc2)c2ccccc2)cc1 ; OCCOCc1ccc(N(c2ccccc2)c2ccccc2)cc1 ; Cc1cc(N(c2ccc(CO)c(C)c2)c2ccc(CO)c(C)c2)ccc1CO ; Cc1cc(N(c2ccc(CO)cc2)c2ccc(-c3ccc(N(c4ccc(CO)cc4)c4ccc(CO)c(C)c4)cc3)cc2)ccc1CO ; OCc1ccc(N(c2ccc(C=C(c3ccccc3)c3ccccc3)cc2)c2ccc(CO)cc2)cc1]

Furthermore, in a case of using a crosslinkable charge transporting material in the protective layer 5, a compound having a guanamine skeleton (structure) (guanamine compound) or a compound having a melamine skeleton (structure) (melamine compound) may be used.

Examples of the guanamine compound include acetoguanamine, benzoguanamine, formoguanamine, stearoguanamine, spiroguanamine, and cyclohexylguanamine.

The guanamine compound is particularly preferably at least one of compounds represented by the following formula (A) and multimers thereof. Here, the multimers are oligomers in which a compound represented by the formula (A) is polymerized as a structural unit, and the degree of polymerization is, for example, from 2 to 200 (preferably from 2 to 100). In addition, the compound represented by the formula (A) may be used singly or in combination of two or more kinds thereof.

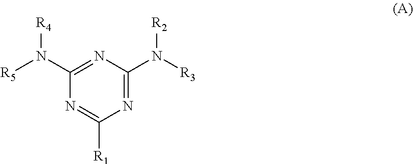

In the formula (A), R₁ represents a straight-chain or branched alkyl group having 1 to 10 carbon atoms, a substituted or unsubstituted phenyl group having 6 to 10 carbon atoms, or a substituted or unsubstituted alicyclic hydrocarbon group having 4 to 10 carbon atoms, R₂ to R₅ each independently represent hydrogen, —CH₂—OH, or —CH₂—O—R₆, and R₆ represents a hydrogen atom or a straight-chain or branched alkyl group having 1 to 10 carbon atoms.

Examples of commercially available products of the compound represented by the formula (A) include “SUPER BECKAMIN® L-148-55, SUPER BECKAMIN® 13-535, SUPER BECKAMIN® L-145-60, and SUPER BECKAMIN® TD-126” manufactured by DIC Corporation), and “NIKALACK BL-60 and NIKALACK BX-4000” (both manufactured by Nippon Carbide Industries Co., Inc.).

The fluorine atom-containing resin particles used in the protective layer 5 are constituted with one or two or more kinds selected from the group consisting of polytetrafluoroethylene, perfluoroalkoxyfluorine resin, polychlorotrifluoroethylene, polyvinylidene fluoride, polydichlorodifluoroethylene, a tetrafluoroethylene-perfluoroalkylvinylether copolymer, a tetrafluoroethylene-hexafluoropropylene copolymer, a tetrafluoroethylene-ethylene copolymer, and a tetrafluoroethylene-hexafluoropropylene-perfluoroalkylvinylether copolymer.

The commercially available fluorine atom-containing resin particles may be used as they are. Those having a molecular weight of from 3,000 to 5,000,000 may be used, and those having a particle diameter of from 0.01 μm to 10 μm, and preferably from 0.05 μm to 2.0 μm may be used.

Examples of the commercially available product include LUBRON series (manufactured by Daikin Industries, Ltd.), TEFLON (registered trademark) series (manufactured by E. I. Du Pont de Nemours & Co.), and Dainion series (manufactured by Sumitomo 3M Co.).

Examples of the oligomer having a fluorine atom include oligomers containing perfluoroalkyl, and preferable examples thereof include perfluoroalkyl sulfonic acids (for example, perfluorobutane sulfonic acid and perfluorooctane sulfonic acid), perfluoroalkyl carboxylic acids (for example, perfluorobutane carboxylic acid and perfluorooctane carboxylic acid), and perfluoroalkyl group-containing phosphoric acid esters.

The perfluoroalkyl sulfonic acids and perfluoroalkyl carboxylic acids may also be in the form of salts thereof and amide modification products thereof. Specific typical examples thereof include GF300 (manufactured by Toagosei Co., Ltd., SURFLON series (manufactured by AGC Seimi Chemical Co., Ltd.), FTERGENT series (manufactured by Neos Co., Ltd.), PF series (manufactured by KITAMURA Chemical Co., Ltd.) MEGAFACE series (manufactured by DIC Corporation), FC series (manufactured by 3M), POLYFLOW KL600 (manufactured by Kyoeisha Chemical Co., Ltd.), and EFTOP series (all manufactured by Japan. Electronic Monetary Claim Organization (JEMCO)). The commercially available fluorine atom-containing resin particles may be used as they are or as a mixture of plural kinds thereof.

The melamine compound has a melamine skeleton (structure), and is preferably at least one of a compound represented by the following formula (B) or a multimer thereof. Here, the multimer is an oligomer in which the compound represented by the formula (B) is polymerized as a structural unit in the same manner as described above for the formula (A). The polymerization degree thereof is, for example, from 2 to 200 and preferably from 2 to 100.

The compound represented by the formula (B) or a multimer thereof may be used singly or may be used in combination of two or more kinds thereof. The compound represented by the formula (B) or a multimer thereof may be used in combination with the compound represented by the formula (A) or a multimer thereof.

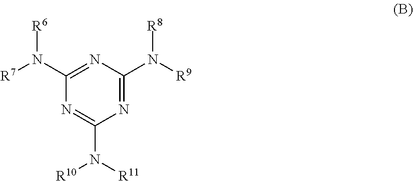

In the formula (B), R⁶ to R¹¹ each independently represent a hydrogen atom, —CH₂—OH, or —CH₂—O—R¹², and R¹² represents a straight-chain or branched alkyl group having 1 to 5 carbon atoms. Examples of R¹² include a methyl group, an ethyl group, and a butyl group.

Examples of the commercially available product of the compound represented by the formula (B) include SUPER MELAMI No. 90 (manufactured by NOF Corporation), SUPER BECKAMINE® TD-139-60 (manufactured by DIC Corporation), U-VAN 2020 (manufactured by Mitsui Chemicals, Inc.), SUMITEX RESIN M-3 (manufactured by Sumitomo Chemical Co., Ltd.), and NIKALACK MW-30 (manufactured by Nippon Carbide Industries Co., Inc.).

The protective layer 5 is formed by coating a coating liquid containing the constituents. The coating liquid for forming a protective layer may be prepared without a solvent, or if necessary, using a solvent such as alcohols such as methanol, ethanol, propanol, and butanol; ketones such as acetone and methyl ethyl ketone; and ethers such as tetrahydrofuran, diethylether, and dioxane. These solvents may be used singly or as a mixture of two or more kinds thereof, but they preferably have a boiling point of 100° C. or lower. In particular, a solvent having one or more kinds of hydroxyl groups (for example, alcohols) may be preferably used.

Incidentally, by coating the coating liquid for forming a protective layer on the charge transporting layer 3 using an ordinary method such as a blade coating method, a wire bar coating method, a spray coating method, a dipping coating method, a bead coating method, an air knife coating method, and a curtain coating method, and if necessary, for example, by heating and curing the coating liquid for forming a protective layer at a temperature of from 100° C. to 170° C., a protective layer 5 is obtained.

Process Cartridge and Image Forming Apparatus

Next, a process cartridge and an image forming apparatus, each using the electrophotographic photoreceptor of the present exemplary embodiment, will be described.

The process cartridge of the present exemplary embodiment is configured to include the electrophotographic photoreceptor of the present exemplary embodiment and a toner removing unit that has a member in contact with a surface of the electrophotographic photoreceptor and removes the toner remaining on the surface of the electrophotographic photoreceptor, and is detachable from an image forming apparatus.

Furthermore, the image forming apparatus of the present exemplary embodiment is configured to include the electrophotographic photoreceptor of the present exemplary embodiment, a charging unit that charges a surface of the electrophotographic photoreceptor, an electrostatic latent image forming unit that forms an electrostatic latent image on a charged surface of the electrophotographic photoreceptor, a developing unit that develops the electrostatic latent image formed on the surface of the electrophotographic photoreceptor by a developer containing a toner to form a toner image, a transfer unit that transfers the toner image formed on the surface of the electrophotographic photoreceptor onto a recording medium, and a toner removing; unit that has a member in contact with the surface of the electrophotographic photoreceptor and removes the toner remaining on the surface of the electrophotographic photoreceptor.

The image forming apparatus of the present exemplary embodiment may be a so-called tandem machine having plural photoreceptors corresponding to the respective toner colors, and in this case, all of the photoreceptors are preferably the electrophotographic photoreceptors of the present exemplary embodiment. Further, the transfer of the toner image may be an intermediate transfer mode having an intermediate transfer member.

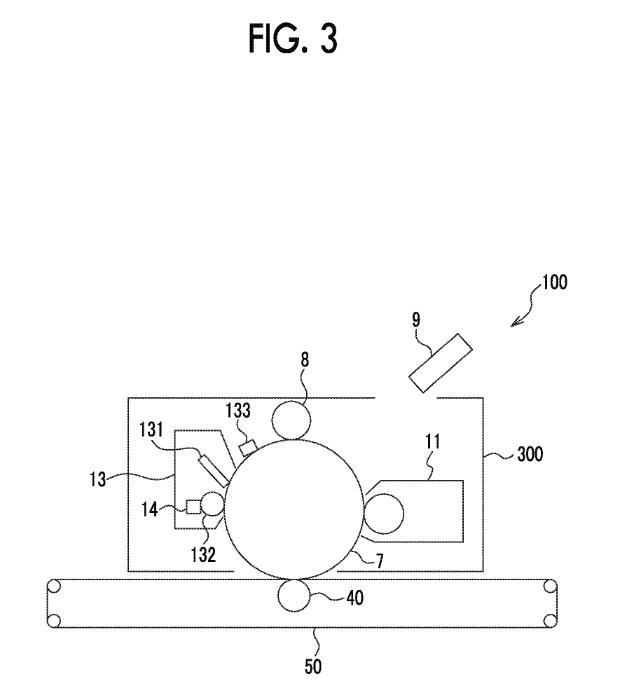

FIG. 3 is a schematic configuration view showing an example of the image forming apparatus according to the exemplary embodiment of the invention. The image forming apparatus 100 includes, as shown in FIG. 3, a process cartridge 300 having an electrophotographic photoreceptor 7, an exposure device 9, a transfer device 40, and an intermediate transfer member 50. In the image forming apparatus 100, the exposure device 9 is disposed at a position where the electrophotographic photoreceptor 7 may be exposed through the opening of the process cartridge 300, and the transfer device 40 is disposed at a position opposite to the electrophotographic photoreceptor 7 through the intermediate transfer member 50. The intermediate transfer member 50 is disposed such that a part thereof is in contact with the electrophotographic photoreceptor 7.

The process cartridge 300 constituting a part of the image forming apparatus 100 shown in FIG. 3 supports, in an integrated manner, an electrophotographic photoreceptor 7, a charging device 8 (an example of a charging unit), a developing device 11 (an example of a developing unit), and a cleaning device 13 (an example of a toner removing unit) in a housing. The cleaning device 13 has a cleaning blade 131 (cleaning member), and the cleaning blade 131 is disposed to be in contact with the surface of the electrophotographic photoreceptor 7 to remove the toner remaining on the surface of the electrophotographic photoreceptor 7.

There is disclosed an example of the cleaning device 13, which uses a fibrous member 132 (roller-shaped) that supplies a lubricating member 14 to the surface of the photoreceptor 7, and a fibrous member 133 (flat brush-shaped) that assists cleaning, in addition to the cleaning blade 131, but these may or may not be used.

As the charging device 8, for example, a contact type charging device using a conductive or semiconductive charging roller, a charging brush, a charging film, a charging rubber blade, a charging tube, or the like is used. Further, known charging devices such as a non-contact type roller charging device, a scorotron charging device, and a corotron charging device using corona discharge are also used.

Moreover, although not shown in the view, a photoreceptor heating member for increasing the temperature of the electrophotographic photoreceptor 7, thereby lowering the relative temperature, may be provided in the periphery of the electrophotographic photoreceptor 7.

The exposure device 9 (an example of an electrostatic latent image forming unit) may be, for example, an optical instrument which exposes, in a predetermined imagewise manner, the surface of the photoreceptor 7 to light such as a semiconductor laser light, an LED light, or a liquid crystal shutter light. For the wavelength of the light source, a wavelength that belongs to the spectral sensitivity region of the photoreceptor is used. The principal range of the wavelength of the semiconductor laser light is near-infrared having an emission wavelength at near 780 nm. However, the wavelength of the light source is not limited to this wavelength, and a laser light having an emission wavelength in the region of 600 nm, or a blue laser light having an emission wavelength of approximately from 400 nm to 450 nm may also be used. Further, surface light-emitting type laser light source that may output multiple beams is also effective for the formation of color images.

As the developing device 11, for example, a general developing device which performs development using a magnetic or non-magnetic single-component developer, a two-component developer, or the like in a contact or non-contact manner may be used. The developing device is not particularly limited as long as the device has the function described above, and is selected according to the purpose. For example, a known developing machine having a function of attaching the single-component developer or the two-component developer to the photoreceptor 7 using a brush, a roller or the like, may be used. Among these, it is preferable to use a developing device employing a developing roller which holds the developer at the surface.

Hereinafter, the toner that is used in the developing device 11 will be described.

The toner is not particularly limited in terms of the preparation method, but for example, toners prepared by a kneading pulverization method of adding a binder resin, a colorant and a release agent, as well as other additives such as a charge-controlling agent and the like, and performing kneading, pulverization, and classification; a method of modifying the shape of the particles obtained by the kneading pulverization method, by means of mechanical impact force or thermal energy; an emulsion polymerization aggregation method of emulsion polymerizing polymerizable monomers of a binder resin, mixing the dispersion thus formed with a dispersion containing a colorant and a release agent, as well, as other additives such as a charge-control ng agent, and subjecting the mixture to aggregation and heat coalescence no obtain toner particles; a suspension polymerization method of suspending polymerizable monomers for obtaining a binder resin, and a solution containing a colorant and a release agent, as well as other additives such as a charge-controlling agent, in an aqueous solvent, and performing polymerization; a dissolution suspension method of suspending a binder resin, and a solution containing a colorant and a release agent, as well, as other additives such as a charge-controlling agent, in an aqueous solvent and granulating the suspension; and the like are used.

Furthermore, known methods such as a preparation method of using a toner obtained by the methods described above as the core, further attaching aggregated particles thereto, and thermally fusing the toner and the particles to give a core-shell structure, are used. As the method for preparing a toner, a suspension polymerization method, an emulsion polymerization aggregation method, and a dissolution suspension method, which produce toners in aqueous solvents, are preferable from the viewpoints of controlling the shape and the particle size distribution, and an emulsion polymerization aggregation method is particularly preferable.

The toner particles preferably contain a binder resin, a colorant, and a release agent, and may further contain silica or a charge-controlling agent.

Examples of the binder resin that is used in the toner particles include homopolymers and copolymers of styrenes such as styrene and chlorostyrene; monoolefins such as ethylene, propylene, butylene, and isoprene; vinyl esters such as vinyl acetate, vinyl propionate, vinyl benzoate, and vinyl butyrate; α-methylene aliphatic monocarboxylic acid esters such as methyl acrylate, ethyl acrylate, butyl acrylate, dodecyl acrylate, octyl acrylate, phenyl acrylate, methyl methacrylate, ethyl methacrylate, butyl methacrylate, and dodecyl methacrylate; vinyl ethers such as vinyl methyl ether, vinyl ethyl ether, and vinyl butyl ether; and vinyl ketones such as vinyl methyl ketone, vinyl hexyl ketone, and vinyl isopropenyl ketone, and polyester resins obtained by copolymerization of dicarboxylic acids and dials.

Particularly representative examples of the binder resin include polystyrene, a styrene-alkyl acrylate copolymer, a styrene-alkyl methacrylate copolymer, styrene-acrylonitrile copolymer, a styrene-butadiene copolymer, a styrene-maleic anhydride copolymer, polyethylene, polypropylene, and a polyester resin. Other examples of the binder resin include a polyurethane, an epoxy resin, a silicone resin, a polyamide, a modified rosin, and paraffin wax.

Furthermore, representative examples of the colorant include magnetic powders such as magnetite and ferrite; carbon black, aniline blue, calco oil blue, chrome yellow, ultramarine blue, Du Pont oil red, quinoline yellow, methylene blue chloride, phthalocyanine blue, malachite green oxalate, lamp black, Rose Bengal, C.I. Pigment Red 48:1, C. I. Pigment Red 122, C.I. Pigment Red 57:1, C. I. Pigment Yellow 97, C. I. Pigment. Yellow 17, C. I. Pigment. Blue 15:1, and C. I. Pigment Blue 15:3.

Representative examples of the release agent include low molecular weight polyethylene, low molecular weight polypropylene, Fischer-Tropsch wax, montan wax, carnauba wax, rice wax, and candellila wax.

As the charge-controlling agent, known compounds are used, and, for example, azo metal complexes, salicylic acid-metal complexes, and resin type charge-controlling agents containing polar groups are used. In a case where the toner is produced by a wet production method, it is preferable so use a material that is not easily dissolved in water. Further, the toner may be any of a magnetic toner including a magnetic material, and a non-magnetic toner that does not contain a magnetic material.

The toner used in the developing device 11 is prepared by mixing the toner particles and the external additives in a Henschel mixer, a V blender or the like. Further, in the case of producing toner particles by a wet method, external addition may be carried out in a wet manner.

Lubricant particles may be added to the toner that is used in the developing device 11. Examples of the lubricant particles include solid lubricants such as graphite, molybdenum disulfide, talc, fatty acids, and fatty acid metal salts; low molecular weight polyolefins such as polypropylene, polyethylene, and polybutene; silicones having softening points by heating; aliphatic amides such as oleic acid amide, erucic acid amide, ricinolic acid amide, and stearic acid amide; plant waxes such as carnauba wax, rice wax, candellila wax, wood wax, and jojoba oil; animal waxes such as beeswax; mineral and petroleum waxes such as montan wax, ozokerite, ceresin, paraffin wax, microcrystalline wax, and Fischer-Tropsch wax; and modified products thereof. These may be used individually, or two or more kinds may be used in combination.

To the toner that is used in the developing device 11 may be further added inorganic particles, organic particles, complex particles in which inorganic particles are attached to the organic particles, and the like.

Preferable examples of the inorganic particles include various inorganic oxides, nitrides and borides such as silica, alumina, titania, zirconia, barium titanate, aluminum titanate, strontium titanate, magnesium titanate, zinc oxide, chromium oxide, cerium oxide, antimony oxide, tungsten oxide, tin oxide, tellurium oxide, manganese oxide, boron oxide, silicon carbide, boron carbide, titanium carbide, silicon nitride, titanium nitride, and boron nitride.

Furthermore, the inorganic particles may be treated with a titanium coupling agent such as tetrabutyl titanate, tetraoctyl titanate, isopropyltriisostearoyl titanate, isopropyltridecylbenzenesulfonyl titanate, and bis(dioctylpyrophosphate)oxyacetate titanate; and a silane coupling agent such as 3-(2-aminoethyl)aminopropyltrimethoxysilane, 3-(2-aminoethyl)aminopropylmethyldimethoxysilane, 3-methacryloxypropyltrimethoxysilane, N-2-(N-vinylbenzylaminoethyl)-3-aminopropyltrimethoxysilane hydrochloride, hexamethyldisilazane, methyl trimethoxysilane, butyltrimethoxysilane, isobutyltrimethoxysilane, hexyltrimethoxysilane, octyltrimethoxysilane, decyltrimethoxysilane, dodecyltrimethoxysilane, phenyltrimethoxysilane, o-methylphenyltrimethoxysilane, and p-methylphenyltrimethoxysilane. Further, inorganic particles that have been subjected to a hydrophobization treatment using silicone oil or higher fatty acid metal salts such as aluminum stearate, zinc stearate, and calcium stearate, are also favorably used.

Examples of the organic particles include styrene resin particles, styrene-acrylic resin particles, polyester resin particles, and urethane resin particles.

Any known compound may be used as other inorganic oxide to be added to the toner, but it is preferable to use silica and titanium oxide in combination.

The inorganic particles having small diameters may also be surface-treated. It is also preferable to add carbonates such as calcium carbonate and magnesium carbonate, or inorganic minerals such as hydrotalcite.

The electrophotographic color toner may be used as a mixture with a carrier, and examples of the carrier include powdered iron, glass beads, powdered ferrite, powdered nickel, and products obtained by coating the surfaces of these powders and beads with a resin. Further, the mixing ratio of the electrophotographic color toner to the carrier may be defined according to necessity.

Examples of the transfer device 40 (an example of a transfer unit) include known transfer charging devices, such as a contact type transfer charging device using a belt, a roller, a film, a rubber blade, or the like; and a scorotron transfer charging device or corotron transfer charging device using corona discharge.

Examples of the intermediate transfer member 50 that may be used include belt-shaped transfer bodies (intermediate transfer belts) made of polyimide, polyamideimide, polycarbonate, polyarylate, polyester, rubber, and the like, which have been imparted with semiconductivity. Further, in regard to the shape of the intermediate transfer member 50, a transfer member having a drum shape is used in addition to the belt-shaped transfer member.

The image forming apparatus 100 may include, in addition to the various devices described above, for example, a photoerasing device for photoerasing the photoreceptor 7.

In the image forming apparatus 100 shown in FIG. 3, the surface of the photoreceptor 7 is charged by the charging device 8, and after forming an electrostatic latent image by the exposure device 9, the electrostatic latent image on the surface of the photoreceptor 7 is developed as a toner image by a toner in the developing device 11. The toner image on the photoreceptor 7 is transferred to the intermediate transfer belt 50, the toner image is then transferred onto the surface of the recording medium (not shown), and is thereafter fixed by a fixing device, not shown.

Furthermore, in a monochromatic image forming apparatus, the recording medium is transported to a position where the transfer device 40 and the photoreceptor 7 are disposed opposite to each other by a recording medium transporting belt, not by an intermediate transfer belt 50, and the toner image is transferred onto the recording medium and then fixed.

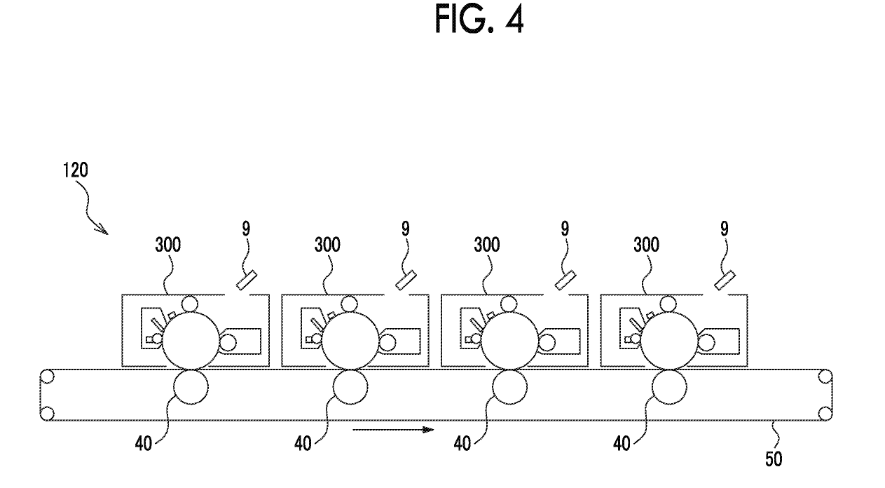

FIG. 4 is a schematic configuration view showing an image forming apparatus according to another exemplary embodiment. The image forming apparatus 120 is a tandem type multi-color image forming apparatus equipped with four process cartridges 300, as show in FIG. 4. The image forming apparatus 120 has a configuration in which the four process cartridges 300 are disposed in parallel on the intermediate transfer member 50, and one electrophotographic photoreceptor is used per color. Further, the image forming apparatus 120 has the same configuration as the image forming apparatus 100, except for being a tandem type.

### EXAMPLES

Hereinafter, Examples of the present invention will be described, but the present invention is not limited to the following Examples.

### Example 1

### Preparation of Electrophotographic Photoreceptor

### Preparation of Substrate

An aluminum alloy having a content of aluminum of 99% is homogenized at 180° C. for 40 minutes. Using a blast machine, scratches having a depth of 8 μm, a length of 50 μm, a width of 50 μm are generated on the surface of an aluminum alloy matrix at 30 scratches/cm², and an impact press processing is carried out. Thus, a cylindrical aluminum substrate having a thickness of 0.5 mm, and an Ra of 1.3 μm and an Rmax of 3.5 μm as a surface roughness is prepared. Further, as the surface roughness of the substrate, both of Ra and Rmax are measured by a surface roughness measurement machine (SURFCOM manufactured by Tokyo Seimitsu Co., Ltd.).

Formation of Undercoat Layer

100 parts by weight of zinc oxide (average particle diameter of 70 nm: manufactured by Tayca Corp.: specific surface area of 15 m²/g) is mixed with 500 parts by weight of toluene under stirring, and 1.3 parts by weight of a silane coupling agent (KBM603: manufactured by Shin-Etsu Chemical Co., Ltd., N-2-(aminoethyl)-3-aminipropyltrimethoxysilane) is added thereto, followed by stirring for 2 hours. Subsequently, toluene is distilled away under reduced pressure and the baking is carried out at 120° C. for 3 hours, thereby obtaining silane coupling agent-surface treated zinc oxide.

110 parts by weight of the surface treated zinc oxide is mixed with 500 parts by weight of tetrahydrofuran under stirring, and a solution prepared by dissolving 0.6 part by weight of alizarin in 50 parts by weight of tetrahydrofuran is added thereto, followed by stirring at 50° C. for 5 hours. Subsequently, the alizarin-applied zinc oxide is separated by filtration under reduced pressure, and is dried under reduced pressure at 60° C., thereby obtaining alizarin-applied zinc oxide.

38 parts by weight of a solution prepared by dissolving 60 parts by weight of this alizarin-applied zinc oxide, 13.5 parts by weight of a curing agent (blocked isocyanate, SUMIDUR 3175, manufactured by Sumitomo Bayer Urethane Co., Ltd.), and 15 parts by weight of a butyral resin (S-LEC BM-1, manufactured by Sekisui Chemical Co., Ltd.) in 85 parts by weight of methyl ethyl ketone is mixed with 25 parts by weight of methyl ethyl ketone, and the mixture is dispersed in a sand mill using glass beads having a diameter of 1 mmφ for 2 hours, thereby obtaining a dispersion.

0.005 part by weight of dioctyltin dilaurate as a catalyst and 40 parts by weight of silicone: resin particles (TOSPEARL 145, manufactured by GE Toshiba Silicones Co., Ltd.) are added to the dispersion thus obtained, and a coating liquid for forming an undercoat layer is obtained. This coating liquid is applied on an aluminum substrate having a diameter of 30 mm, a length of 340 mm, and a thickness of 0.5 mm by a dipping coating method, and the coating liquid is dried and cured at 170° C. for 40 minutes, thereby obtaining an undercoat layer having a thickness of 19 μm.

Formation of Charge Generating Layer

A mixture of 15 parts by weight of hydroxygallium phthalocyanine having diffraction peaks at Bragg's angles (2θ±0.2°) of at least 7.5°, 9.9°, 12.5°, 16.3°, 18.6°, 25.1°, and 28.3° in the X-ray diffraction spectrum obtained using CuKα characteristic X-rays as a charge generating material, 10 parts by weight of a vinyl chloride-vinyl acetate copolymer resin (VMCH, manufactured by Nippon Unicar Co., Ltd.) as a binder resin, and 200 parts by weight of n-butyl acetate is dispersed in a sand mill using glass beads having a diameter of 1 mmφ for 4 hours. 175 parts by weight of n-butyl acetate and 180 parts by weight of methyl ethyl ketone are added to the obtained dispersion, followed by stirring. Thus, a coating liquid for forming a charge generating layer is obtained. This coating liquid for forming a charge generating layer is dipping-coated on the undercoat layer, and is dried at normal temperature (25° C.), thereby forming a charge generating layer having a film thickness of 0.2 μm.

Formation of Charge Transporting Layer

Next, 0.5 part by weight of ethylene tetrafluoride resin particles (average primary particle diameter of 0.2 μm) and 0.01 part by weight of a fluorinated alkyl group-containing copolymer (weight average molecular weight in terms of polystyrene as measured by gel permeation chromatography (GPC) of 200,000, l:m=1:1, s=1, n=60) containing the repeating units represented by the following structural formulae A-1 and B-1 are kept at a liquid temperature of 20° C. together with 4 parts by weight of tetrahydrofuran and 1 part by weight of toluene, followed by stirring and mixing for 48 hours, thereby obtaining an ethylene tetrafluoride resin particle suspension (solution A).

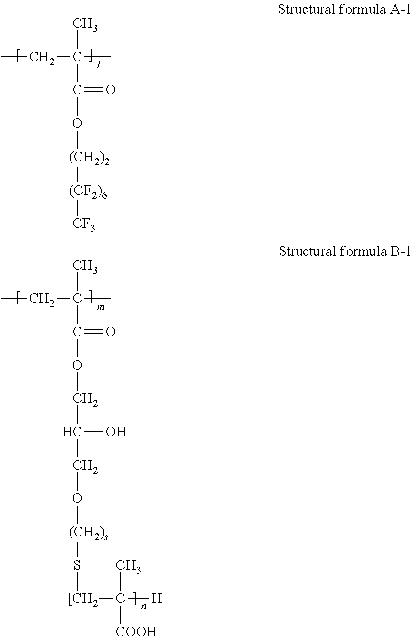

Next, parts by weight of N,N′-bis(3-methylphenyl)-N,N′-diphenylbenzidine and 2 parts by weight of N,N′-bis(3,4-dimethylphenyl)biphenyl-4-amine as a charge transporting material, 6 parts by weight of a bisphenol Z type polycarbonate resin (viscosity average molecular weight of 40,000) as a binder resin, and 0.1 part by weight of 2,6-di-4-methylphenol as an antioxidant are mixed to obtain a solution B having 24 parts by weight, of tetrahydrofuran and 11 parts by weight of toluene mixed in and dissolved therein.

To the solution B is added the solution A, followed by stirring and mixing, and then a dispersion treatment is repeated three times with an elevated pressure of 500 kgf/cm² using a high-pressure homogenizer equipped with a penetrated chamber having fine channels (Yoshida. Kikai. Co., Ltd.) to obtain a solution, and 5 ppm of a dimethylsilicone oil (trade name: KP-340 manufactured by Shin-Etsu Silicon is added to the solution, followed by stirring, thereby obtaining a coating liquid for forming a charge transporting layer.

This coating liquid for forming a charge transporting layer is coated on the charge generating layer by dipping coating, and dried at 135° C. for 25 minutes to form a charge transporting layer having a film thickness of 20 μm, thereby obtaining an electrophotographic photoreceptor.

### Example 2

By the same method as in Example 1 except that the number of scratches on the surface of the aluminum alloy matrix is 20 scratches/cm², the depth of the scratches on the surface is 6 μm, and an aluminum substrate having an Ra of 1.0 μm and an Rmax of 3.0 μm as a surface roughness is prepared, a photoreceptor is prepared.

### Example 3

By the same method as in Example 1 except that the number of scratches on the surface of the aluminum alloy matrix is 20 scratches/cm², the depth of the scratches on the surface is 12 μm, and an aluminum substrate having an Ra of 1.0 μm and an Rmax of 4.0 μm as a surface roughness is prepared, a photoreceptor is prepared.

### Example 4

By the same method as in Example 1 except that the number of scratches on the surface of the aluminum alloy matrix is 40 scratches/cm², the depth of the scratches on the surface is 6 μm, and an aluminum substrate having an Ra of 1.7 μm and an Rmax of 3.0 μm as a surface roughness is prepared, a photoreceptor is prepared.

### Example 5

By the same method as in Example 1 except that the number of scratches on the surface of the aluminum alloy matrix is 40 scratches/cm², the depth of the scratches on the surface is 12 μm, and an aluminum substrate having an Ra of 1.7 μm and an Rmax of 4.0 μm as a surface roughness is prepared, a photoreceptor is prepared.

### Example 6

By the same method as in Example 1 except that an aluminum substrate having a thickness of 0.3 mm is prepared, a photoreceptor is prepared.

### Example 7

By the same method as in Example 1 except that an aluminum substrate haying a thickness of 1.0 mm is prepared, a photoreceptor is prepared.

### Example 8

By the same method as in Example 1 except that a charge transporting layer obtained by adding 1.0 part by weight of ethylene tetrafluoride resin particles is prepared, a photoreceptor is prepared.

### Example 9

By the same method as in Example 1 except that a charge transporting layer obtained by adding 0.1 part by weight of ethylene tetrafluoride resin particles is prepared, a photoreceptor is prepared.

### Example 10

The outer peripheral surface of the cylindrical aluminum substrate (thickness of 0.5 mm, outer diameter of 30 mm) is cut using a lathe with a diamond tool. Thus, an aluminum substrate having an Ra of 1.3 μm and an Rmax of 3.5 μm as a surface roughness is prepared. By the same method as in Example 1, an undercoat layer, a charge generating layer, and a charge transporting layer are sequentially formed on the aluminum substrate to prepare a photoreceptor.

### Comparative Example 1

By the same method as in Example 1 except that the number of scratches on the surface of the aluminum alloy matrix is 10 scratches/cm², the depth of the scratches on the surface is 6 μm, and an aluminum substrate having an Ra of 0.8 μm and an Rmax of 3.0 μm as a surface roughness is prepared, a photoreceptor is prepared.

### Comparative Example 2

By the same method as in Example 1 except that the number of scratches on the surface of the aluminum alloy matrix is 10 scratches/cm², the depth of the scratches on the surface is 12 μm, and an aluminum substrate having an Ra of 0.8 μm and an Rmax of 4.0 μm as a surface roughness is prepared, a photoreceptor is prepared.

### Comparative Example 3

By the same method as in Example 1 except that the number of scratches on the surface of the aluminum alloy matrix is 20 scratches/cm², the depth of the scratches on the surface is 4 μm, and an aluminum substrate having an Ra of 1.0 μm and an Rmax of 2.5 μm as a surface roughness is prepared, a photoreceptor is prepared.

### Comparative Example 4

By the same method as in Example 1 except that the number of scratches on the surface of the aluminum alloy matrix is 20 scratches/cm², the depth of the scratches on the surface is 16 μm, and an aluminum substrate having an Ra of 1.0 μm and an Rmax of 4.5 μm as a surface roughness is prepared, a photoreceptor is prepared.

### Comparative Example 5

By the same method as in Example 1 except that the number of scratches on the surface of the aluminum alloy matrix is 40 scratches/cm², the depth of the scratches on the surface is 4 μm, and an aluminum substrate having an Ra of 1.7 μm and an Rmax of 2.5 μm as a surface roughness is prepared, a photoreceptor is prepared.

### Comparative Example 6

By the same method as in Example 1 except that the number of scratches on the surface of the aluminum alloy matrix is 40 scratches/cm², the depth of the scratches on the surface is 16 μm, and an aluminum substrate having an Ra of 1.7 μm and an Rmax of 4.5 μm as a surface roughness is prepared, a photoreceptor is prepared.

### Comparative Example 7

By the same method as in Example 1 except that the number of scratches on the surface of the aluminum alloy matrix is 50 scratches/cm², the depth of the scratches on the surface is 6 μm, and an aluminum substrate having an Ra of 1.9 μm and an Rmax of 3.0 μm as a surface roughness is prepared, a photoreceptor is prepared.

### Comparative Example 8

By the same method as in Example 1 except that the number of scratches on the surface of the aluminum alloy matrix is 50 scratches/cm², the depth of the scratches on the surface is 12 μm, and an aluminum substrate having an Ra of 1.9 μm and an Rmax of 4.0 μm as a surface roughness is prepared, a photoreceptor is prepared.

### Comparative Example 9

By the same method as in Example 1 except that a charge transporting layer is prepared without the addition of ethylene tetrafluoride resin particles, a photoreceptor is prepared.

The electrophotographic photoreceptor thus obtained is loaded on a full-color printer, Docu Centre Color C400 manufactured by Fuji Xerox Corporation, having a contact charging device and an intermediate transfer device, and image formation is carried out on 10,000 sheets of A4 paper (manufactured by Fuji Xerox Corporation, C2 paper).

The torque value, slipping through a cleaning blade in image quality, the black spots, and the interference fringes at the time of image formation are checked. Specifically, the measurement or evaluation is carried out as follows.

Torque Value

Using a manual torque gauge in the state where the photoreceptor is attached to the cartridge before the test, the maximum start-up torque of the photoreceptor is taken as a torque value.

By taking Example 3 as a standard, the torque values are evaluated according to the following criteria.

A: Much lower than the standard.

B: Equivalent to or slightly higher than the standard.

C: Higher than the standard.

Slipping through a cleaning blade in Image Quality

Visually judged.

Black Spots

Visually judged.

Interference Fringes

Visually judged.

For the evaluation of slipping through a cleaning blade in image quality, black spots, and interference fringes, the results of Example 4 are taken as a standard and evaluation is carried out according to the following criteria.

A: Much improved as compared with the standard.

B: Equivalent to or slightly poor as compared with the standard.

C: Deteriorated as compared with the standard.

The Ra, the Rmax, the content of PTFE, and the evaluation results of the outermost surface layer (charge transporting layer) of each of the photoreceptors prepared in Examples and Comparative Examples are summarized in Table 1 below.

TABLE 1

| | | | Content of | | | | |
|---|---|---|---|---|---|---|---|
| | | | PTFE in | | | | |
| | | | outermost | | | | |
| | Surface | | surface | Evaluation | | | |
| | roughness of | | layer | | Slipping | | |
| | substrate | | Content | | through a | | Inter- |
| | Ra | Rmax | (% by | Torque | cleaning | Black | ference |
| | (μm) | (μm) | weight) | value | blade | spots | fringes |
| Ex. 1 | 1.3 | 3.5 | 0.5 | A | A | A | A |
| Ex. 2 | 1.0 | 3.0 | 0.5 | B | A | A | B |
| Ex. 3 | 1.0 | 4.0 | 0.5 | B | A | B | A |
| Ex. 4 | 1.7 | 3.0 | 0.5 | A | B | B | B |
| Ex. 5 | 1.7 | 4.0 | 0.5 | A | B | B | A |
| Ex. 6 | 1.3 | 3.5 | 0.5 | A | A | B | B |
| Ex. 7 | 1.3 | 3.5 | 0.5 | A | A | B | A |
| Ex. 8 | 1.3 | 3.5 | 1.0 | A | A | B | A |
| Ex. 9 | 1.3 | 3.5 | 0.1 | B | A | A | A |
| Ex. 10 | 1.3 | 3.5 | 0.5 | A | A | A | A |
| Comp. | 0.8 | 3.0 | 0.5 | C | A | A | B |
| Ex. 1 | | | | | | | |
| Comp. | 0.8 | 4.0 | 0.5 | C | A | B | A |
| Ex. 2 | | | | | | | |
| Comp. | 1.0 | 2.5 | 0.5 | B | A | A | C |
| Ex. 3 | | | | | | | |
| Comp. | 1.0 | 4.5 | 0.5 | B | A | C | A |
| Ex. 4 | | | | | | | |
| Comp. | 1.7 | 2.5 | 0.5 | A | B | A | C |
| Ex. 5 | | | | | | | |
| Comp. | 1.7 | 4.5 | 0.5 | A | B | C | A |
| Ex. 6 | | | | | | | |
| Comp. | 1.9 | 3.0 | 0.5 | A | C | A | B |
| Ex. 7 | | | | | | | |
| Comp. | 1.9 | 4.0 | 0.5 | A | C | B | A |
| Ex. 8 | | | | | | | |
| Comp. | 1.3 | 3.5 | 0.0 | C | A | A | A |
| Ex. 9 | | | | | | | |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents

What is claimed is:

1. An electrophotographic photoreceptor comprising:
a conductive substrate having a centerline average roughness (Ra) of from 1.0 μm to 1.7 μm and a maximum height (Rmax) of from 3.0 μm to 4.0 μm as a surface roughness; and
a photosensitive layer disposed on the conductive substrate,
wherein the outermost surface layer contains fluorine-containing particles.

2. The electrophotographic photoreceptor according to claim 1, wherein the centerline average roughness (Re) of the surface roughness is from 1.1 μm to 1.5 μm.

3. The electrophotographic photoreceptor according to claim 1, wherein the centerline average roughness (Ra) of the surface roughness is from 1.2 μm to 1.4 μm.

4. The electrophotographic photoreceptor according to claim 1, wherein the maximum height (Rmax) is from 3.2 μm to 3.8 μm.

5. The electrophotographic photoreceptor according to claim 1, wherein the maximum height (Rmax) is from 3.4 μm to 3.6 μm.

6. The electrophotographic photoreceptor according to claim 1, wherein the thickness of the conductive substrate is from 0.4 mm to 0.7 mm.

7. The electrophotographic photoreceptor according to claim 1, wherein the thickness of the conductive substrate is from 0.4 mm to 0.5 mm.

8. The electrophotographic photoreceptor according to claim 6, wherein the conductive substrate is formed by an impact press processing.

9. An image forming apparatus comprising:
the electrophotographic photoreceptor according to claim 1;
a charging unit that charges a surface of the electrophotographic photoreceptor;
an electrostatic latent image forming unit that forms an electrostatic latent image on a charged surface of the electrophotographic photoreceptor;
a developing unit that develops the electrostatic latent image formed on the surface of the electrophotographic photoreceptor by a developer containing a toner to form a toner image;
a transfer unit that transfers the toner image formed on the surface of the electrophotographic photoreceptor onto a recording medium; and
a toner removing unit that has a member in contact with the surface of the electrophotographic photoreceptor and removes the toner remaining on the surface of the electrophotographic photoreceptor.

10. A process cartridge comprising:
the electrophotographic photoreceptor according to claim 1; and
a toner removing unit that has a member in contact with a surface of the electrophotographic photoreceptor and removes the toner remaining on the surface of the electrophotographic photoreceptor, and
being detachable from an image forming apparatus.
